(19) United States
(12) Patent Application Publication
(10) Pub. No.: US 2025/0356470 A1
(43) Pub. Date: Nov. 20, 2025

(54) DISTORTION CORRECTION DEVICE AND METHOD

(71) Applicant: MediaTek Singapore Pte. Ltd., Singapore (SG)

(72) Inventor: Yang LIU, Shenzhen (CN)

(21) Appl. No.: 18/678,266

(22) Filed: May 30, 2024

(30) Foreign Application Priority Data
May 15, 2024 (CN) 202410605577.9

(51) Int. Cl. G06T 5/80; G06T 3/18; G06T 3/40; G06T 5/50; G06T 7/11

(52) U.S. Cl. CPC G06T 5/80; G06T 3/18; G06T 3/40; G06T 5/50; G06T 7/11; G06T 2207/10016; G06T 2207/20132; G06T 2207/20221

(57) ABSTRACT

Provided is a distortion correction method that integrates image operations. The method includes reforming a warp map through one or more image operations. The image operations include cropping, geometric transformation, stitching, or a combination thereof. The method further includes using the reformed warp map to transform an input image into an output image.

### CROSS REFERENCE TO RELATED APPLICATIONS

This Application claims priority of China Patent Application No. 202410605577.9, filed on May 15, 2024, the entirety of which is incorporated by reference herein.

### BACKGROUND OF THE INVENTION

### Field of the Invention

The present invention relates to image processing, and, in particular, to a device and method for distortion correction.

### Description of the Related Art

Distortion is a phenomenon stemming from imperfections in a photographic lens. The optical elements in the lens may not refract light perfectly, leading to the bending of light rays and the subsequent distortion of the captured scene, which can manifest as barrel distortion and pincushion distortion. Barrel distortion causes straight lines to appear curved outward, while pincushion distortion results in straight lines appearing curved inward. These distortions are particularly noticeable at the edges of the image and can be more pronounced with wide-angle lenses.

Distortion can be corrected by warping the image with a reverse distortion. This process involves determining the correspondence between each distorted pixel in the uncorrected image and its undistorted counterpart in the corrected image. Due to the non-linearity of the distortion, it is impractical to use a simple function or formula to map between pixels of the uncorrected and corrected images. Consequently, a one-to-one mapping table that records the mapping relationship between each distorted pixel in the uncorrected image and its corresponding undistorted pixel in the corrected image, is often used to transform an uncorrected image into a corrected image. This mapping table is commonly referred to as a “warp map.”

FIG. 1 illustrates a conventional image processing pipeline P10. As depicted in FIG. 1, an image captured by a photography device 11 undergoes a series of stages S12-S17 before being output for display or storage. In stage S12, the image captured by the photography device 11 undergoes image signal processing, including, for example, demosaicing, noise reduction, image sharpening, and gamma correction. Subsequently, in stage S13, the previously mentioned warp map is applied for distortion correction. Following distortion correction, various image operations are applied to the corrected image in stages S14-S17, collectively referred to as image operations 150. In the example shown in FIG. 1, these image operations 150 include cropping in stage S14, stitching in stage S17, and geometric transformation 160 that further includes rotation in stage S15 and scaling in stage 16. It should be understood that the depiction of stages S14-S17 in FIG. 1 is illustrative, and in practice, the image operations may involve more or fewer operations than just those illustrated. Geometric transformation 160 may further include operations such as shearing, reflection, translation, orthogonal projection, among others. Additionally, the execution order of these image operations 150 can vary, although cropping is typically performed at the outset, and stitching is typically performed at the end.

As evident from FIG. 1, the image processing pipeline P10 involves numerous stages, particularly in the case of image operations 150. Furthermore, each stage in FIG. 1 inevitably introduces some latency. Although image operations 150 are typically implemented using efficient graphics processing units (GPUs) or dedicated circuits, the accumulated delays from numerous stages may still become substantial. For instance, assuming a processing requirement of 60 frames per second, implying a 1/60-second delay for each stage, the distortion correction together with image operations 150, spanning five stages S13-S17, results in a total delay of 5/60 seconds. This cumulative delay can impact user experience in certain performance-demanding applications such as image streaming, autonomous driving, or gaming.

Recognizing the aforementioned challenges, a distortion correction solution is presented that can reduce system load and latency by comprehensively handling distortion correction and various image operations in a single stage.

### BRIEF SUMMARY OF THE INVENTION

An embodiment of the present invention provides a distortion correction method for use in a distortion correction device. The method includes the first operation and the second operation. The first operation involves reforming a warp map through one or more image operations. The one or more image operations include cropping, geometric transformation, stitching, or a combination thereof. The second operation involves using the reformed warp map to transform the input image into the output image.

In an embodiment, the geometric transformation is rotation, scaling, or a combination thereof.

In an embodiment, the input image undergoes none of the one or more image operations before the second operation.

In an embodiment, the first operation predetermines the reformed warp map, and the second operation further involves using the reformed warp map predetermined by the first operation to transform each frame of the input image sequence into the output image frame.

In an embodiment, the first operation further involves cropping the warp map to obtain multiple cropped parts from the warp map, performing a geometric transformation on the cropped parts to obtain multiple transformed parts, and stitching the transformed parts into the reformed warp map.

In an embodiment, the first operation further involves performing object detection on the input image to obtain one or more bounding boxes, cropping the warp map based on the bounding boxes to obtain the cropped parts, and performing the geometric transformation on the cropped parts based on the bounding boxes to obtain multiple transformed parts.

In an embodiment, while the second operation is transforming the first frame of an input image sequence, the first operation is reforming the warp map to be used for transforming the second frame subsequent to the first frame of the input image sequence.

In an embodiment, the second operation further involves upscaling the reformed warp map to match the specified resolution of the output image before transforming the input image.

An embodiment of the present invention further provides a distortion correction device. The device includes an integrated circuit. The integrated circuit is configured to use a reformed warp map to transform the input image into the output image. The reformed warp map is predetermined by reforming a warp map through one or more image operations. The one or more image operations include cropping, geometric transformation, stitching, or a combination thereof.

In an embodiment, the integrated circuit performs none of the one or more image operations on the input image sequence.

In an embodiment, the integrated circuit is further configured to upscale the reformed warp map to match the specified resolution of the output image before transforming the input image.

An embodiment of the present invention further provides another distortion correction device. The device includes a storage unit, a processing unit and a distortion correction unit. The storage unit stores at least an input image and a warp map. The processing unit coupled to the storage unit, for accessing the warp map from the storage unit, reforming the warp map through one or more image operations, and storing the reformed warp map into the storage unit. The distortion correction unit, coupled to the storage unit and the processing unit, for receiving a control signal from the processing unit, accessing the input image and the reformed warp map from the storage unit according to the control signal, and transforming the input image into an output image by using the reformed warp map. The one or more image operations include cropping, geometric transformation, stitching, or a combination thereof.

In an embodiment, the processing unit performs none of the one or more image operations on the input image.

In an embodiment, the processing unit predetermines the reformed warp map by reforming the warp map through the one or more image operations, and the distortion correction unit uses the predetermined reformed warp map to transform the input image sequence into the output image sequence.

In an embodiment, the processing unit reforms the warped map by cropping the warp map to obtain multiple cropped parts from the warp map, performing the geometric transformation on the cropped parts to obtain multiple transformed parts, and stitching the transformed parts into the reformed warp map.

In an embodiment, the processing unit further performs object detection on the input image to obtain one or more bounding boxes, crops the warp map based on the bounding boxes to obtain the cropped parts, and performs the geometric transformation on the cropped parts based on the bounding boxes to obtain multiple transformed parts.

In an embodiment, while transforming the first frame of the input image sequence, the distortion correction unit reforms the warp map to be used for transforming the second frame subsequent to the first frame of the input image sequence.

In an embodiment, the distortion correction unit further upscales the reformed warp map to match the specified resolution of the output image before transforming the input image.

### BRIEF DESCRIPTION OF THE DRAWINGS

The present invention can be more fully understood by reading the subsequent detailed description and examples with references made to the accompanying drawings, wherein:

FIG. 1 illustrates a conventional image processing pipeline;

FIG. 2 illustrates a novel image processing pipeline, according to an embodiment of the present disclosure;

FIG. 3 is the schematic diagram of a distortion correction method that integrates image operations, according to an embodiment of the present disclosure;

FIG. 4A is the flow diagram of an exemplary implementation of reforming the warp map, according to an embodiment of the present disclosure;

FIG. 4B showcases an exemplary reformed warp map, which results from the warp map undergoing the first operation, according to an embodiment of the present disclosure;

FIG. 5 is the block diagram of a distortion correction device that integrates image operations, according to an embodiment of the present disclosure; and

FIG. 6 is the block diagram of a distortion correction device that integrates image operations, according to another embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

As previously explained, warp map is a one-to-one mapping table that records the mapping relationship between each distorted pixel in the uncorrected image and its corresponding undistorted pixel in the corrected image. More specifically, each pixel of the warp map indicates the location in the uncorrected image from which to retrieve pixel values for the corrected/warped image. Consequently, any operations performed on the warp map, such as cropping, geometric transformation, and/or stitching, ultimately manifest in the warped image. This underlying principle is leveraged in embodiments of the present disclosure.

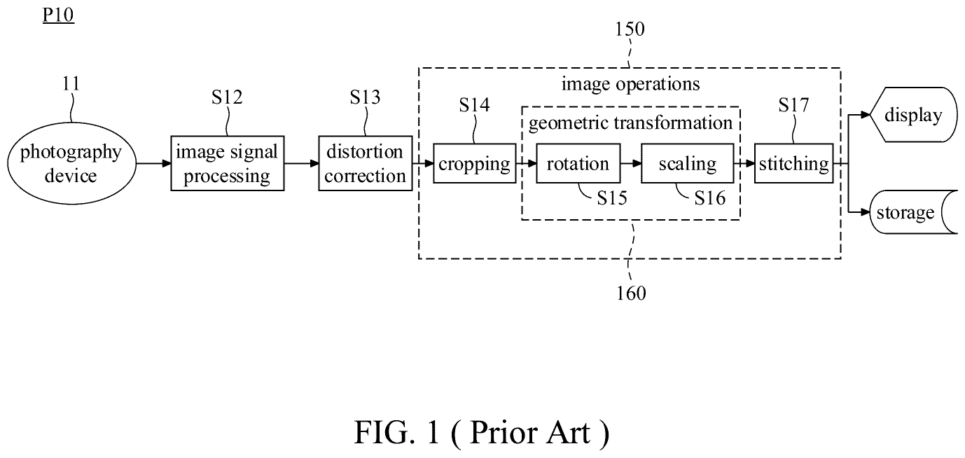

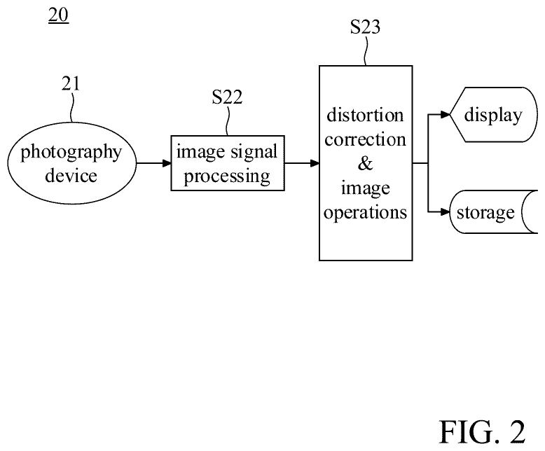

FIG. 2 illustrates a novel image processing pipeline P20, according to an embodiment of the present disclosure. As depicted in FIG. 2, the image captured by the photography device 21 undergoes only two stages S22 and S23, before being output for display or storage. In stage S22, similar to stage S12 in FIG. 1, the captured image undergoes image signal processing. The primary distinction of the image processing pipeline P20 compared to P10 lies in stage S23, where distortion correction and image operations are consolidated. Since stage 23 has generated the output image required for display or storage, image operation steps such as stages S14-S17 illustrated in FIG. 1 are not needed.

The advantage of stage S23 includes the fact that there is no additional delay compared to stage S13 in FIG. 1. This is because both stage S23 and stage S13 use a warp map to transform the input image into the output image for distortion correction, with the distortion correction in stage S23 using a reformed warp map obtained after the image operation. In other words, although stage 23 in FIG. 2 also includes image operations, these image operations are performed on the warp map, instead of being performed on the input image as illustrated in FIG. 1. In other words, the input image does not have to undergo similar image operations 150 in FIG. 1. Since the warp map is a mapping table recording the mapping relationship with a part of the pixels in the input image, it does not contain the real pixel coordinates, but the horizontal and vertical mapping components. In some embodiments, what is recorded in the warp map is not the mapping relationship of all pixels in the input image. Therefore, in comparison, image operations performed on the warp map consume much less time and resources than image operations performed on the input image. Additionally, the distortion correction and image operations included in stage 23 can be performed in parallel, that is to say, while calculating the reformed warp map for the next frame in the input image sequence, the previously obtained reformed warp map can be used to transform the current input frame into the current output frame of the output image sequence, resulting in reduced waiting time and improved overall processing speed.

Again, assuming a processing requirement of 60 frames per second, implying a 1/60-second delay for each stage, distortion correction along with image operations are accomplished in a single stage S23, resulting in a mere 1/60-second delay. This amounts to 20% of the delay incurred by the image processing pipeline P10.

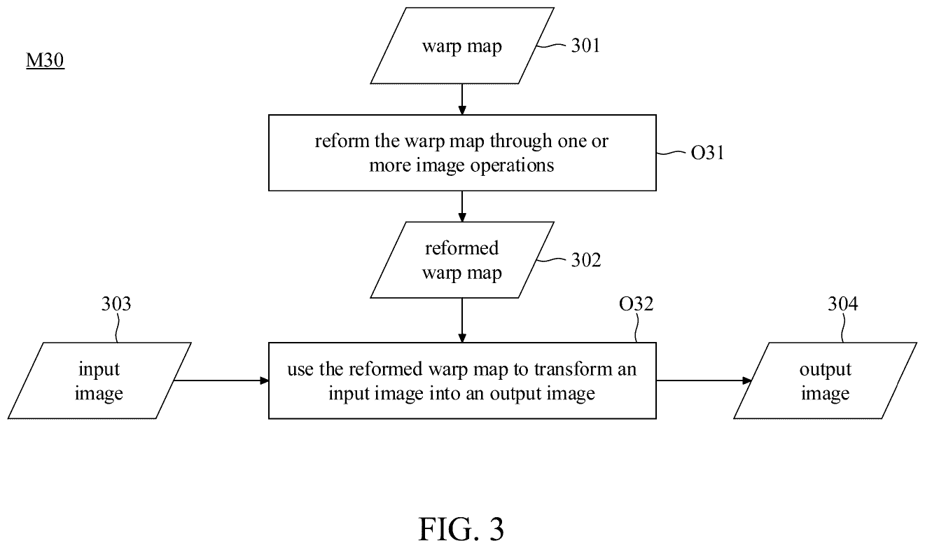

FIG. 3 is the schematic diagram of a distortion correction method 30 that integrates image operations, according to an embodiment of the present disclosure. As depicted in FIG. 3, method M30 includes a first operations O31 and a second operation O32.

The first operation O31 involves reforming the warp map 301 through one or more image operations to obtain a reformed warp map 302. As previously mentioned, the warp map 301 is used for distortion correction, but any operations performed on the warp map 301 will also reflect in the output image 304 besides the effect of distortion correction. Therefore, the initially anticipated image operations on the input image 303 or the corrected image (i.e., the result of applying the warp map 301 to the input image 303 for distortion correction), which is time-consuming, can be redirected to operate on the warp map instead. The resulting output image 304 will still exhibit the effects of distortion correction as well as image operations. Additionally, it is worth noting that the computational workload required for performing image operations on the warp map 301 is typically smaller than that required for performing image operations on the input image 303. This is because the input image 303 usually consists of multiple channels. For example, an input image 303 defined in the RGB color space has three channels-R (red), G (green), and B (blue). Image operations need to be computed for each of these color channels in the prior art. In contrast, according to the present disclosure, the warp map 301 only requires a single channel to record the mapping relationship, thus resulting in a smaller computational workload for performing image operations on it.

In this embodiment, the image operations include cropping, geometric transformation, stitching, or any combination thereof. To further elaborate, cropping involves the removal of unwanted areas, retaining only the desired portions. Geometric transformation involves altering the spatial arrangement or shape of an image through operations such as rotation, scaling, shearing, translation, reflection, orthogonal projection, or any combination thereof. Stitching involves combining multiple images or image segments along common edges to create a new composite image.

The second operation O32 involves using the reformed warp map 302 to transform the input image 303 into the output image 304. With reference to the image processing pipeline P20 depicted in FIG. 2, the input image 303 is an image that has not undergone distortion correction and image operations, but may have undergone image signal processing in stage S22, such as demosaicing, noise reduction, image sharpening, and gamma correction, though not necessary. The output image 304 is an image that has undergone distortion correction and image operations in stage S23, making it ready for display and storage.

It should be appreciated that, since the initially anticipated image operations on the input image 303 or the corrected image have been performed on the warp map 301 by the first operation, the input image 303 only needs to undergo transformation using the reformed warp map 302 that integrates the image operations, without needing to undergo these image operations again. Therefore, in an embodiment, the input image 303 undergoes none of the image operations before the second operation O32.

In an embodiment, the specified resolution of both the warp map 301 and the reformed warp map 302 may be smaller than that of the output image 304. For instance, while the output image 304 may be specified to have a high-definition resolution of 1920*1080, the warp map 301 and the reformed warp map 302 may have resolutions of only 100*100. Therefore, the second operation O32 may involve upscaling the reformed warp map to match the resolution of the output image 304 before transforming the input image 303. This upscaling process can be achieved using approaches such as bilinear interpolation, bicubic interpolation, or deep learning techniques, but the present disclosure is not limited thereto.

In an embodiment, the geometric transformation is rotation, scaling, or a combination thereof. This gives rise to three scenarios: distortion correction solely integrating rotation, distortion correction solely integrating scaling, and distortion correction integrating both rotation and scaling.

Taking rotation as an example of the geometric transformation in this image operation, the specific calculation method of the first operation O31 is presented below. For rotation by an angle θ counterclockwise (positive direction) about the origin, the functional form is:

$$\{ \begin{matrix}{x}^{′} = x cos θ - y sin θ \\ {y}^{′} = x sin θ + y cos θ\end{matrix}$$

where x and y are respectively the horizontal and vertical mapping components of the warp map 301 corresponding to the pixels of the input image 303, while x′ and y′ are respectively the horizontal and vertical mapping components of the warp map 301 after rotation. Written in matrix form, this becomes:

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ]$$

where

$$[ \begin{matrix}cos θ & - sin θ \\ sin θ & cos θ\end{matrix} ]$$

is referred to as the rotation matrix.

Taking scaling as an example of the geometric transformation in this image operation, the specific calculation method of the first operation O31 is presented below. For scaling by a factor of h along the x-axis and k along the y-axis, with the assumption that h and k are independent, the functional form is:

$$\{ \begin{matrix}{x}^{′} = hx \\ {y}^{′} = ky\end{matrix}$$

where x and y are respectively the horizontal and vertical mapping components of the warp map 301 corresponding to the pixels of the input image (it may also be the horizontal and vertical mapping components of the warp map 301 after the above rotation operation), while x′ and y′ are respectively the scaled horizontal and vertical mapping components of warp map 301, this becomes:

$$[ \begin{matrix}{x}^{′} \\ {y}^{′}\end{matrix} ] = [ \begin{matrix}h & 0 \\ 0 & k\end{matrix} ] [ \begin{matrix}x \\ y\end{matrix} ]$$

where

$$[ \begin{matrix}h & 0 \\ 0 & k\end{matrix} ]$$

is referred to as the scaling matrix.

In the case where the geometric transformation is the combination of rotation and scaling, indicating that distortion correction integrates both rotation and scaling, the horizontal and vertical mapping components of the warp map 301 after geometric transformation can be calculated through the matrix multiplication of the rotation matrix

$$[ \begin{matrix}cos θ & - sin θ \\ sin θ & cos θ\end{matrix} ]$$

and the scaling matrix

$$[ \begin{matrix}h & 0 \\ 0 & k\end{matrix} ] .$$

However, it should be noted that matrix multiplication does not necessarily follow the commutative property, meaning the execution order for rotation and scaling matters. Detailed mathematical formulas are not provided herein.

In an embodiment, the reformed warp map 302 is predetermined by the first operation O31. Consequently, the second operation O32 may use the reformed warp map predetermined by the first operation O31 to transform each frame of the input image sequence into the output image frame. To elaborate further, in practical application scenarios of the image processing pipeline, such as the illustrated image processing pipeline P20 in FIG. 2, there is no need to repeatedly execute the operation O31 to obtain the reformed warp map 302. This is because the parameters for image operations required for each frame of the image sequence are identical, allowing the reformed warp map 302 to be applied to each frame of an input image sequence. This embodiment is particularly suitable for applications where the shooting scene is relatively static, the transformation requirements for the input image are fixed, and do not change with environmental variations, such as in a surveillance system. For example, stores, banks, or schools may deploy cameras at specific locations, each positioned at a specific angle to monitor specific areas. Therefore, parameters of image operations, such as cropping, geometric transformation, and stitching, may be fixed to ensure clear visibility of multiple areas presented simultaneously on surveillance center screens. By pre-applying image operations to the warp map 301, the image processing pipeline is relieved from the time-consuming image operations, thereby enhancing overall efficiency.

In an embodiment, each frame of the input image sequence corresponds to a variable warp map. Additionally, both the first operation O31 and the second operation O32 are performed in parallel. Specifically, while the second operation O32 is transforming the current frame of an input image sequence, the first operation O31 is reforming the warp map to be used for transforming the subsequent frame of the input image sequence. This embodiment is particularly suitable for real-time applications where the required image operations vary with changes in the environment, such as in video conferencing. For example, the reformed warp map 302 may change as the number and/or positions of participants change.

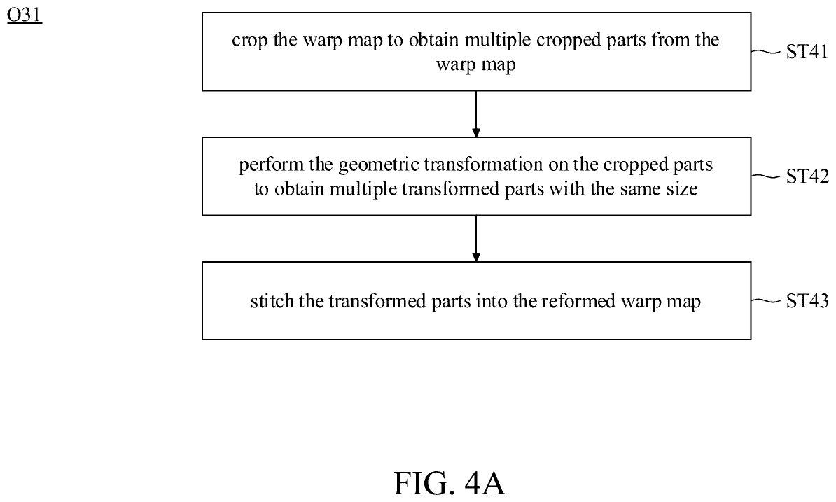

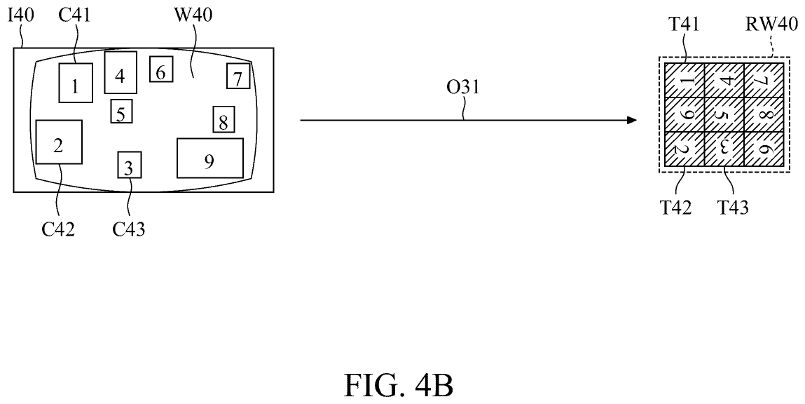

FIG. 4A is the flow diagram of an exemplary implementation of the first operation O31 in which cropping, geometric transformation, and stitching are executed sequentially, according to an embodiment of the present disclosure. As shown in FIG. 4A, the first operation O31 may include steps ST41-43. Correspondingly, FIG. 4B showcases an exemplary reformed warp map RW40, which results from the warp map 40 undergoing the first operation O31, according to this embodiment. Please refer to both FIG. 4A and FIG. 4B for a better understanding to this embodiment.

In step ST41, the warp map W40 is cropped to obtain multiple cropped parts from the warp map. The cropped parts are the desired portions retained after unwanted areas being removed. As shown in the example provided in FIG. 4B, the warp map 40 corresponds to the input image 140. During step ST41, nine cropped parts are derived from the warp map 40, including the first cropped part C41, the second cropped part C42, the third cropped part C43, along with other six cropped parts. Apart from their distinct positions, these cropped parts may also vary in sizes, including differences in lengths and/or widths.

In step ST42, geometric transformation is performed on the cropped parts to obtain multiple transformed parts. As shown in the example provided in FIG. 4B, the first cropped part C41, the second cropped part C42, and the third cropped part C43 are transformed into the first transformed part T41, the second transformed part T42, and the third transformed part T43, respectively. The first transformed part T41 is rotated counterclockwise by 90 degrees relative to the first cropped part C41. The second transformed part T42 is rotated counterclockwise by 270 degrees and resized to a smaller size relative to the second cropped part C42. The third transformed part T43 is rotated counterclockwise by 180 degrees and resized to a larger size relative to the third cropped part C43. Similarly, the other six cropped parts undergo corresponding transformations into their respective transformed parts.

In step ST43, the transformed parts are stitched into the reformed warp map RW40. As shown in the example provided in FIG. 4B, the resulting reformed warp map RW40 consists of the first transformed part T41, the second transformed part T42, the third transformed part T43, and the other six transformed parts. It's worth noting that although the reformed warp map RW40 is depicted in FIG. 4B as a nine-square grid, with each square representing transformed parts such as the first transformed part T41, the second transformed part T42, and the third transformed part T43, all of which are squares of equal size, this depiction serves as an example rather than a constraint. In various implementations, the reformed warp map RW40 may not necessarily be square, and the transformed parts may not necessarily share the same size. The primary objective is to ensure that the input image 303 maps to the output image 304 as per the specifications of the display output.

Afterwards, the reformed warp map RW40 can be used by the second operation O32 to transform and map the regions on input image 140 that correspond to the nine cropped parts to the output image. For example, like the reformed warp map RW40, the output image is composed of a nine-square grid formed by stitching together nine square image regions. The region on input image 140 corresponding to the first cropped part C41 undergoes the same operation as step ST42 performed on the first cropped part C41, namely, a counterclockwise rotation of 90 degrees and resizing to suitable size, and then mapped to the top-left region of the output image. Similarly, the region on input image 140 corresponding to the second cropped part C42 undergoes the same operation as step ST42 performed on the second cropped part C42, namely, a counterclockwise rotation of 270 degrees and resizing to suitable size, and then mapped to the bottom-left region of the output image. The region on input image 140 corresponding to the third cropped part C43 undergoes the same operation as step ST42 performed on the third cropped part C43, namely, a counterclockwise rotation of 180 degrees and resizing to suitable size, and then mapped to the middle-bottom region of the output image. Other six regions follow the same procedure. It's worth mentioning again that the present disclosure does not require all cropped parts to be resized to the same size. The primary objective is to ensure that the resized parts can be seamlessly stitched together to meet the display output specifications.

In an embodiment, the first operation O31 further includes performing object detection on the input image to obtain one or more bounding boxes. Additionally, the cropping for the warp map in step ST41, as well as the geometric transformation performed on the cropped parts in step ST42, are based on the bounding boxes. To elaborate further, the bounding box is a rectangle that encompasses the detected object (e.g., human face) region in the input image 303. This region can be defined by coordinates of the top-left vertex and the coordinates of the bottom-right vertex of the rectangle. The warp map is then cropped to only retain the pixels within the bounding box, ensuring that subsequent distortion correction and image operations focus specifically on the detected face area. Additionally, each detected object in the cropped parts can be resized based on the size of the bounding box. For example, let's assume that the ideal size for an object to be displayed is M×N pixels. In the case of a small bounding box with size M/2×N/3 pixels, the scaling factors h and k would be set to 2 and 3, respectively, to ensure that the image region of the detected object is resized to the appropriate dimensions. This targeted approach enhances the efficiency and precision of the distortion correction process for facial features. Additionally, since the reformed warp map is composed of multiple transformed parts with adequate size, it ensures that the detected faces in the input image 303 will be transformed to appear adequate in size. This is particularly beneficial for applications such as video conferencing and surveillance. In video conferencing, for instance, when multiple participants are in the same camera frame, despite of their distance from the camera, this approach ensures that no participants' head sizes appear too small on the screen, consolidating the presence and engagement of each participant in the conference. However, the size of each participant's head does not need to be displayed uniformly. For instance, the head of the meeting host or the person speaking can be enlarged and placed in the center of the screen. In surveillance, for instance, by simultaneously monitoring students' attentiveness in a classroom using a camera device, this method approaches fair monitoring of students in different seating positions.

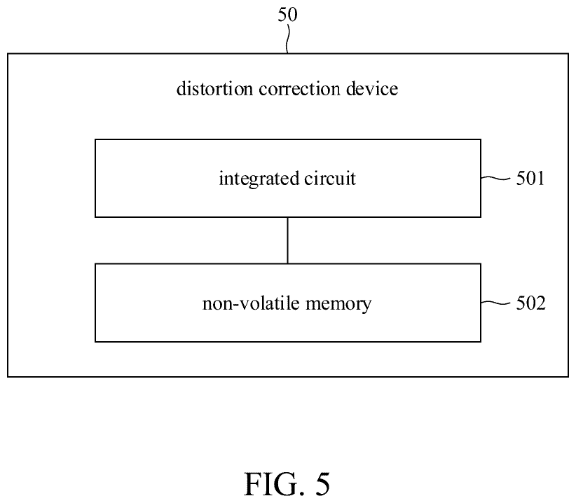

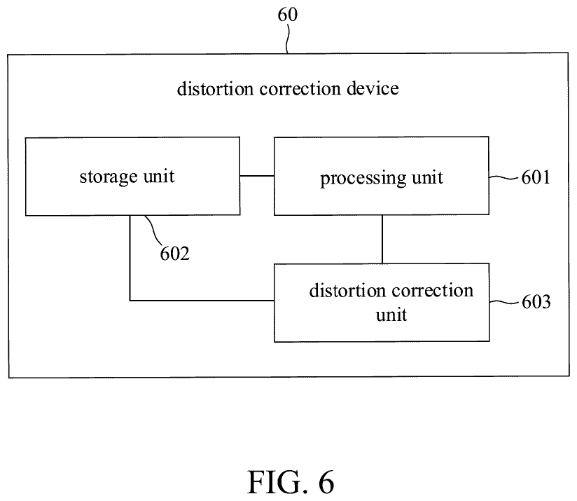

Various embodiments of the distortion correction method M30 are applied in a distortion correction device, which can be either a specifically designed hardware device or a general-purpose computer system driven by a software program. The structure of these aspects of the distortion correction device will be described with reference to FIG. 5 and FIG. 6.

FIG. 5 is the block diagram of a distortion correction device 50 that integrates image operations, according to an embodiment of the present disclosure. The distortion correction device 50 includes an integrated circuit 501, such as application-specific integrated circuits (ASIC), field programmable gate arrays (FPGA) and/or system-on-chip (SoC), configured to execute various embodiments of the second operation O32 described above. Additionally, the distortion correction device 50 may further include a non-volatile memory 502, for storing the reformed warp map 302. The non-volatile memory 502 may include Read-Only Memory (ROM), Electrically-Erasable Programmable Read-Only Memory (EEPROM), flash memory, Non-Volatile Random Access Memory (NVRAM), or any combination thereof.

FIG. 6 is the block diagram of a distortion correction device 60 that integrates image operations, according to another embodiment of the present disclosure. In this embodiment, the distortion correction device 60 is a computer system capable of executing computational tasks, such as a personal computer (including desktop computer, laptop computer, tablet computer, etc.), or a server computer. The distortion correction device 60 includes a processing unit 601, which may include one or more general-purpose processors such as central processing unit (CPU), graphics processing unit (GPU), a microprocessor, or a microcontroller. The processing unit 601 may further include random-access memory (RAM), such as Dynamic Random-Access Memory (DRAM), Static Random-Access Memory (SRAM), and/or a combination thereof, but the present disclosure is not limited thereto. The distortion correction device 60 further includes a storage unit 602, which can be any storage device with non-volatile memory, such as Read-Only Memory (ROM), Electrically-Erasable Programmable Read-Only Memory (EEPROM), flash memory, or Non-Volatile Random Access Memory (NVRAM). Examples of such devices include Hard Disk Drive (HDD) arrays, Solid State Drives (SSD), or optical discs, but the present disclosure is not limited thereto. The processing unit 601 can communicate with the storage unit 602 through various wired or wireless communication interfaces, such as system buses, Serial ATA (SATA), Serial Attached SCSI (SAS), NVM Express (NVMe), PCI Express (PCIe), Universal Serial Bus (USB) interfaces, USB Type-C interfaces, Thunderbolt interfaces, 5th generation (5G) wireless systems, Wi-Fi, and/or any combination thereof, but the present disclosure is not limited thereto. According to the embodiments of the present disclosure, the storage unit 602 is coupled to the processing unit 601, and stores at least the input image and the warp map. The processing unit 601 is configured to read the warp map from the storage unit 601 and perform various embodiments of the first operation O31. Specifically, the processing unit 601 modifies the warp map by using one or more image operations to obtain a reformed warp map and stores it into the storage unit 601. The distortion correction device 60 further includes a distortion correction unit 603. The distortion correction unit 603 is coupled to the processing unit 601 and the storage unit 602. The distortion correction unit 603 receives the control signal sent from the processing unit 601, reads the input image and the reformed warp map from the storage unit 601 according to the received control signal, and performs various embodiments of the second operation O32. Specifically, the distortion correction unit 603 uses the reformed warp map to transform the input image into an output image, and stores the output image in the storage unit 601 for subsequent display by a display device, or directly displays the output image.

The above distortion correction unit 603 can be implemented using a central processing unit (CPU), a graphics processing unit (GPU), etc., or can also be implemented using a specialized hardware unit. The distortion correction device 60 may use a general-purpose CPU or GPU to implement the processing unit and use specialized hardware to implement the distortion correction unit. CPU and GPU have better computing capabilities for handling real-time dynamic situations. Therefore, using the CPU or GPU to implement a processing unit to calculate the reformed warp map can achieve the purpose of updating the warp map in real time according to needs. When the distortion correction unit is implemented using a specialized hardware unit, it is more efficient than using a general-purpose CPU or GPU. It can also reduce the workload of the CPU or GPU and improve the performance and response speed of the overall system. Since the distortion correction unit is implemented using a specialized hardware unit, its function and required operations for distortion correction tasks are singular, making it more stable, reliable, and capable of reducing the probability of errors. In short, the use of a specialized distortion correction unit combined with the use of a general-purpose CPU or GPU can improve the processing efficiency of specific tasks and the overall performance of the system while maintaining system flexibility and powerful computing capabilities.

In one embodiment, the one or more image operations include cropping, geometric transformation, stitching, or a combination thereof. The geometric transformation is rotation, scaling or a combination thereof.

In one embodiment, processing unit 601 performs none of the above-described one or more image operations on the input image.

In one embodiment, the processing unit 601 predetermines the reformed warp map by reforming the warp map through one or more image operations, and the distortion correction unit 603 uses the predetermined reformed warp map to transform an input image sequence into an output image sequence.

In one embodiment, the processing unit 601 obtains multiple cropped parts from the reformed map by cropping the warp map; performs the geometric transformation on the cropped parts to obtain multiple transformed parts; and stitching the multiple transformed parts into the reformed warp map.

In one embodiment, the processing unit 601 further performs object detection on the input image to obtain one or more bounding boxes, crops the warp map according to the one or more bounding boxes to obtain the cropped parts, and performs the geometric transformation on the cropped parts based on the bounding boxes to obtain multiple transformed parts.

In one embodiment, while transforming a first frame of an input image sequence, the distortion correction unit 603 reforms the warp map to be used for transforming the second frame subsequent to the first frame of the input image sequence.

In one embodiment, the distortion correction unit 603 further upscales the reformed warp map to match the specified resolution of the output image before transforming the input image.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A distortion correction method, for use in a distortion correction device, the method comprising:
a first operation, including reforming a warp map through one or more image operations to obtain a reformed warp map, wherein the one or more image operations include cropping, geometric transformation, stitching, or a combination thereof; and
a second operation, including using the reformed warp map to transform an input image into an output image.

2. The method as claimed in claim 1, wherein the geometric transformation is rotation, scaling, or a combination thereof.

3. The method as claimed in claim 1, wherein the input image undergoes none of the one or more image operations before the second operation.

4. The method as claimed in claim 1, wherein the first operation predetermines the reformed warp map, and the second operation further includes using the reformed warp map predetermined by the first operation to transform each frame of an input image sequence into an output image frame.

5. The method as claimed in claim 1, wherein the first operation further includes:
cropping the warp map based on the bounding boxes to obtain multiple cropped parts from the warp map;
performing the geometric transformation on the cropped parts to obtain multiple transformed parts; and
stitching the transformed parts into the reformed warp map.

6. The method as claimed in claim 5, wherein the first operation further includes:
performing object detection on the input image to obtain one or more bounding boxes;
cropping the warp map based on the bounding boxes to obtain the cropped parts;
performing the geometric transformation on the cropped parts based on the bounding boxes to obtain multiple transformed parts.

7. The method as claimed in claim 1, wherein while the second operation is transforming a first frame of an input image sequence, the first operation is reforming the warp map to be used for transforming a second frame subsequent to the first frame of the input image sequence.

8. The method as claimed in claim 1, wherein the second operation further includes upscaling the reformed warp map to match a specified resolution of the output image before transforming the input image.

9. A distortion correction device, comprising:
an integrated circuit, configured to use a reformed warp map to transform each frame of an input image sequence into an output image frame, wherein the reformed warp map is predetermined by reforming a warp map through one or more image operations, and wherein the one or more image operations include cropping, geometric transformation, stitching, or a combination thereof.

10. The distortion correction device as claimed in claim 9, wherein the geometric transformation is rotation, scaling, or a combination thereof.

11. The distortion correction device as claimed in claim 9, wherein the integrated circuit performs none of the one or more image operations on the input image sequence.

12. The distortion correction device as claimed in claim 9, wherein the integrated circuit is further configured to upscale the reformed warp map to match a specified resolution of the output image before transforming the input image.

13. A distortion correction device, comprising:
a storage unit, storing at least an input image and a warp map;
a processing unit, coupled to the storage unit, for accessing the warp map from the storage unit, reforming the warp map through one or more image operations, and storing the reformed warp map into the storage unit; and
a distortion correction unit, coupled to the storage unit and the processing unit, for receiving a control signal from the processing unit, accessing the input image and the reformed warp map from the storage unit according to the control signal, and transforming the input image into an output image by using the reformed warp map;
wherein the one or more image operations include cropping, geometric transformation, stitching, or a combination thereof.

14. The distortion correction device as claimed in claim 13, wherein the geometric transformation is rotation, scaling, or a combination thereof.

15. The distortion correction device as claimed in claim 13, wherein the processing unit performs none of the one or more image operations on the input image.

16. The distortion correction device as claimed in claim 13, wherein the processing unit predetermines the reformed warp map by reforming the warp map through the one or more image operations, and the distortion correction unit uses the predetermined reformed warp map to transform an input image sequence into an output image sequence.

17. The distortion correction device as claimed in claim 13, wherein the processing unit reforms the warped map by:
cropping the warp map to obtain multiple cropped parts from the warp map;
performing the geometric transformation on the cropped parts to obtain multiple transformed parts; and
stitching the transformed parts into the reformed warp map.

18. The distortion correction device as claimed in claim 17, wherein the processing unit further performs object detection on the input image to obtain one or more bounding boxes, crops the warp map based on the bounding boxes to obtain the cropped parts, and performs the geometric transformation on the cropped parts based on the bounding boxes to obtain multiple transformed parts.

19. The distortion correction device as claimed in claim 13, wherein while transforming a first frame of an input image sequence, the distortion correction unit reforms the warp map to be used for transforming a second frame subsequent to the first frame of the input image sequence.

20. The distortion correction device as claimed in claim 13, wherein the distortion correction unit further upscales the reformed warp map to match a specified resolution of the output image before transforming the input image.
